(19) United States
(12) Patent Application Publication
(10) Pub. No.: US 2009/0068506 A1
(43) Pub. Date: Mar. 12, 2009

(54) DEVICE AND METHOD FOR MONITORING INTERNAL STATE OF FUEL CELL

(76) Inventor: Takanao Tomura, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/293,342

(22) PCT Filed: Apr. 17, 2007
(86) PCT No.: PCT/IB07/00993

§ 371 Date: Sep. 17, 2008

(30) Foreign Application Priority Data
Apr. 19, 2006 (JP) 2006-115479

(51) Int. Cl. H01M 8/04; H01M 8/02

(52) U.S. Cl. 429/13; 429/12

(57) ABSTRACT

An internal state monitoring device for a fuel cell having multiple separators and an electrolyte sandwiched therebetween includes multiple electrodes for electrical conduction with multiple regions on a surface of a first separator at prescribed contact points in the fuel cell, a collecting portion for collecting currents flowing through the electrodes to give them the same electric potential, sensors for measuring the currents flowing through the electrodes, a load device connected to the fuel cell via the collecting portion and a second separator for variably controlling a load applied between the collecting portion and the second separator, and an extracting-monitoring device for extracting alternating current components, contained in each of the measured electrode currents, generated in response to a change in the load and monitoring the distribution of a state quantity of resistance polarization in the fuel cell based on each of the extracted alternating current components.

### BACKGROUND OF THE INVENTION

1. Field of the Invention

The present invention relates to a technology for monitoring an internal state of a fuel cell.

2. Description of the Related Art

For various purposes such as evaluation of flow path design, fault detection, and quality assurance in a fuel cell, a technology for monitoring an internal state of the fuel cell has been sought, as described in, for example, JP-A-2003-77515, JP-A-9-223512, and JP-A-2004-152501. For example, in a polymer electrolyte fuel cell, the moisture content of electrolyte of a membrane electrode assembly is of importance as an internal state quantity of the fuel cell. This is because the output electric power significantly decreases with a decrease in the moisture content of the electrolyte.

However, a decrease in the output electric power can occur even when the moisture content of the electrolyte is sufficiently large. Usually, water generated in the electrolyte is discharged through a gas flow path disposed in the vicinity of the electrolyte, but the gas flow path may possibly be blocked by the water because of insufficient ventilation of the gas flow path or other reasons. This state is called “flooding.” Since gas cannot flow through the gas flow path smoothly, the supply of gas to the electrolyte decreases, resulting in a decrease in the output electric power. As described above, when flooding occurs, the output electric power decreases despite a high moisture content of the electrolyte. When a decrease in output power occurs in a polymer electrolyte fuel cell as described above, it is difficult to analyze whether it is caused by a decrease in the moisture content of the electrolyte or by flooding due to excessive water. This problem is very important because the above failures require exactly opposite handling when it is caused by a decrease in the moisture content of the electrolyte or by flooding due to excessive water. In addition, this is not a problem peculiar to polymer electrolyte fuel cells but a common problem that needs to be solved in fuel cells having a loss element which changes depending on different internal state quantities such as “activation polarization”, “diffusion polarization”, and “resistance polarization.”

### SUMMARY OF THE INVENTION

The present invention provides a technology for monitoring the distribution state of a state quantity of resistance polarization in an internal state monitoring device and method for monitoring an internal state of a fuel cell.

A first aspect of the present invention is an internal state monitoring device for monitoring an internal state of a fuel cell having an electrolyte and a plurality of separators sandwiching the electrolyte includes: a plurality of electrodes for electrical conduction with a plurality of regions on a surface of a first one of the plurality of separators through contact therewith at prescribed contact points in the fuel cell; a collecting portion for collects currents flowing through the plurality of electrodes to give the same electric potential to the electrodes; sensors for measuring the currents flowing through the plurality of electrodes; a load device connected to the fuel cell via the collecting portion and a second one of the plurality of separators for variably controlling a load applied between the collecting part and the second one of the plurality of separators; and an extracting-monitoring device for extracting alternating current components, contained in each of the measured electrode currents, generated in response to a change in the load and monitoring the distribution of a state quantity of resistance polarization in the fuel cell based on each of the extracted alternating current components.

With the monitoring device of the first aspect of the present invention, a load device for variably controlling a load is connected to a fuel cell, and alternating current components generated in response to a change in the load are extracted and the state quantity distribution of resistance polarization in the fuel cell can be monitored based on each of the extracted alternating current components. Therefore, a state of the electrolyte, for example, can be estimated by monitoring the resistance polarization.

In the above internal state monitoring device, the fuel cell may have a membrane electrode assembly, and the extracting-monitoring device may estimate the moisture content distribution state of the membrane electrode assembly based on the separately monitored distribution state of a state quantity of resistance polarization.

Since membrane electrode assembly, in which an electric double-layer capacitance is formed between the electrolyte and the electrodes, has a significantly high electric capacitance, the electrolyte resistance can be easily separated from the reaction resistance. Therefore, a pronounced effect can be achieved. In addition, estimation of the moisture content of electrolyte separated from a flow path blocking state is very important because the above failures require exactly opposite handling (for example, flow path design or control operation) when it occurs due to flow path blocking or due to excessive moisture content of electrolyte.

In the above internal state monitoring device, the extracting-monitoring device may measure the output voltage of the fuel cell not via the collecting portion but directly, and monitor the distribution of a state quantity of resistance polarization in the fuel cell in each output state based on the output voltage.

In this case, resistances caused by measuring tools including the collecting portion can be removed and the output from the fuel cell can be measured accurately, and an internal state of the fuel cell in various states can be estimated.

In the above internal state monitoring device, each of the alternating current components may be measured depending on an inter-contact-point resistance Rb as a resistance value between the prescribed contact points in the fuel cell, a circuit resistance value Rc as a combined resistance value between the prescribed contact points and the collecting portion, and each of the measured electrode currents. Also, when an expected maximum value of the current output ratio of the fuel cell between the prescribed contact points is defined as maximum output ratio Pr and the allowable error is defined as Er, each of the alternating current components may satisfy the following relation, and the electrode currents measured at the plurality of electrodes may be regarded as currents output at contact points where the electrodes are in contact with the first one of the plurality of separators.

Er>ABS(1−((Pr+1)×Rc+Rb)/(2×Rc+Rb))

where ABS (argument) means a function which returns the absolute value of the argument.

In this case, since measuring error caused by leakage currents which flow between a plurality of electrodes can be reduced to an expected allowable level, the reliability of the measurement can be improved.

Such a configuration can be realized by at least one of an “increase in the inter-contact-point resistance Rb” and a “decrease in the circuit resistance value Rc.” An “increase in the inter-contact-point resistance Rb” can be realized by, for example, an increase in the resistance value of a fuel cell or measuring jig having contact points or an increase in the pitch between contact points. A “decrease in the circuit resistance value Rc” can be realized by, for example, elimination of contact resistance by integration of the circuit of the measuring device or a decrease in the contact resistance by application of a liquid metal on the contact surfaces, which are described later.

In the above monitoring device, the circuit resistance value Rc may be equal to or smaller than one-fifth of the inter-contact-point resistance Rb, and the electrode currents measured at the plurality of electrodes may be regarded simply as currents output at the contact points where the electrodes are in contact with the first one of the plurality of separators.

In this case, since measuring error caused by leakage currents which flow between a plurality of electrodes can be reduced to an accuracy that is generally required in a current density distribution, the reliability of the measurement can be improved easily.

In the above monitoring device, the current density distribution may be measured regarding the circuit resistance value Rc as a combined resistance of a contact resistance between prescribed contact points in the fuel cell and the electrodes and a contact resistance between the electrodes and the collecting portion.

In this case, since most of the circuit resistance value Rc is caused by the contact resistances, when the sum of the contact resistances is regarded as the circuit resistance value Rc, a simple and practical monitoring device can be achieved.

In the above monitoring device, the plurality of electrodes and the collecting portion may be formed integrally, and the current density distribution may be measured regarding the circuit resistance value Rc as a contact resistance between prescribed contact points and the electrodes.

When the electrodes and the collecting portion are integrated to eliminate the contact resistance between the electrodes and the collecting portion as described above, the circuit resistance value Rc can be decreased.

In the above monitoring device, a liquid metal may be applied between the plurality of electrodes and the fuel cell to decrease the contact resistance between each of the plurality of electrodes and the fuel cell.

The circuit resistance value Rc can be decreased also by applying a liquid metal on the contact surfaces to decrease the contact resistance as described above.

In the above monitoring device, the liquid metal may be an alloy containing gallium and indium. Alloys containing gallium and indium are suitable for the purpose because they are not very toxic and have a low resistance value.

In the above monitoring device, the fuel cell may include cell electrodes having reactant gas flow paths, and the distance between contact surfaces between the plurality of electrodes and the fuel cell may be equal to or smaller than the twice the widthwise pitch of the reactant gas flow paths.

In this case, an increase in contact resistance between cell electrodes and the reactant gas flow paths due to unevenness of the pressure from the cell electrodes onto the reactant gas flow paths can be prevented.

In the above monitoring device, the sensors may be offset from each other in the axial direction of the plurality of electrodes so that the pitch between the plurality of electrodes can be smaller than the size of the sensors in a direction perpendicular to the axial direction of the plurality of electrodes.

In this case, the density of measuring points can be increased with the size of the sensors sufficiently large to maintain the sensing accuracy.

In the above monitoring device, the fuel cell may include cell electrodes having reactant gas flow paths, each of the plurality of electrodes having an electrode rod for directing a current to the collecting portion and a contact terminal with an area greater than the cross-sectional area of the electrode for contacting at a prescribed contact point in the fuel cell, and the extracting-monitoring device may further include a pressure plate for pressing all the contact terminals against the fuel cell.

In this case, non-uniformity of the contact resistance between the cell electrodes and the reactant gas flow paths and the contact resistance between the current collection electrodes and the separator due to unevenness of the pressure from the cell electrodes onto raised portions of the reactant gas flow paths can be reduced.

The monitoring device may further include urging portions provided between each of the contact terminals and the pressure plate.

In this case, non-uniformity of the contact resistance between the cell electrodes and the reactant gas flow paths and between the current collection electrodes and the separator can be further reduced and the measurement accuracy can be improved.

In the above monitoring device, each of the plurality of electrodes may further include a contact surface having a center region for electrical conduction through contact and a closed peripheral region surrounding the center region, and the peripheral region may be insulated.

In this case, the distance between contact points can be decreased and the inter-contact-point resistance Rb can be increased.

A second aspect of the present invention is an internal state monitoring method for monitoring an internal state of a fuel cell having an electrolyte and a plurality of separators sandwiching the electrolyte includes; preparing a plurality of electrodes for electrical conduction with a plurality of regions on a surface of a first one of the plurality of separators through contact therewith at prescribed contact points in the fuel cell and a collecting portion for collecting the currents flowing through the plurality of electrodes to give the same electric potential to the electrodes; measuring the currents flowing through the plurality of electrodes; variably controlling a load applied between the collecting portion and a second one of the plurality of the separators using a load device connected to the fuel cell via the collecting portion and a second one of the plurality of separators; and extracting alternating current components, contained in each of the measured electrode currents, generated in response to a change in the load and then monitoring the distribution of a state quantity of resistance polarization in the fuel cell based on each of the extracted alternating current components.

The above aspects of the present invention may be implemented in various forms including a current density distribution measuring method and devices such as a fuel cell control device having the internal state monitoring device and a fuel cell system.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a general configuration diagram of an internal state monitoring device and a fuel cell in a first embodiment of the present invention;

FIG. 2 is an enlarged view of a plurality of measuring electrodes for measuring the current values output from different sections of the separator;

FIG. 3 is an explanatory view illustrating the arrangement of the current collection electrodes on the separator in the first embodiment of the present invention;

FIG. 4 is an explanatory view illustrating an equivalent circuit of an electric circuit including the internal state monitoring device and a fuel cell;

FIG. 5 is an explanatory view illustrating a part of an equivalent circuit of an electric circuit including the internal state monitoring device and a fuel cell;

FIG. 6 is an explanatory view illustrating an example of an equivalent circuit of a section of a fuel cell as a monitoring target;

FIG. 7 is an explanatory view illustrating an integrated measuring electrode in which a current collecting plate is integrated with a plurality of measuring electrodes;

FIG. 8 is an explanatory view illustrating a plurality of measuring electrodes in a first modification;

FIG. 9 is a general configuration diagram of an internal state monitoring device in a second modification;

FIG. 10 is a general configuration diagram of an internal state monitoring device in a third modification;

FIG. 11 is an explanatory view illustrating the contact surface of a current collection electrode of an internal state monitoring device in a fourth modification;

FIG. 12 is an explanatory view illustrating a leakage current which is prevented in the fourth modification;

FIG. 13 is an explanatory view illustrating the manner in which the leakage current is prevented in the fourth modification; and

FIG. 14 is a general configuration diagram of an internal state monitoring device and a fuel cell in a fifth modification.

### DETAILED DESCRIPTION OF THE PREFERRED EMBODIMENTS

Description will be hereinafter made according to an embodiment of the present invention with reference to the accompanying drawings.

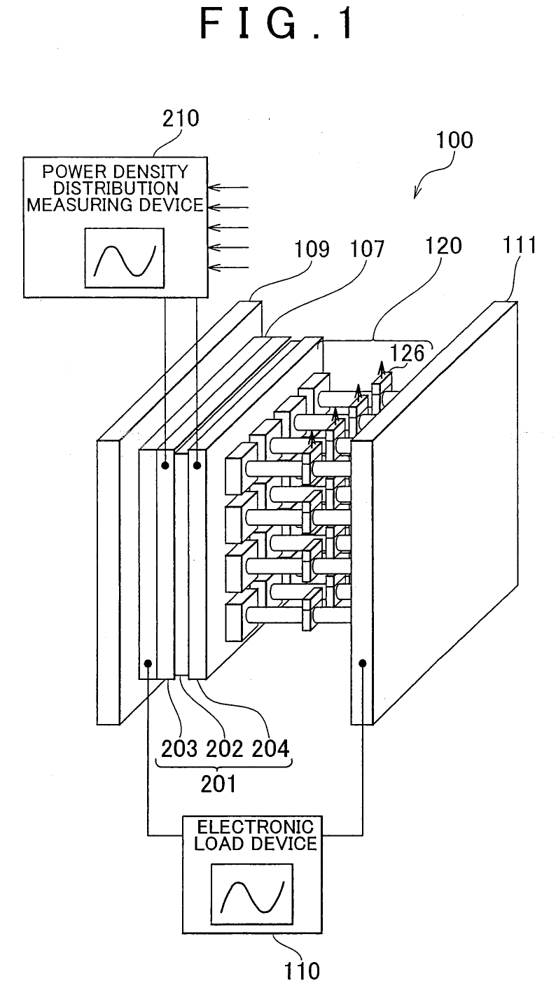

FIG. 1 is a general configuration diagram of an internal state monitoring device 100 and a fuel cell 201 in a first embodiment of the present invention. The internal state monitoring device 100 has a plurality of measuring electrodes 120, a current collecting plate 111, an end plate 109 and a terminal plate 107 as measuring tools, an electronic load device 110, and a power density distribution measuring device 210. In this embodiment, the fuel cell 201 is a monitoring target of the internal state monitoring device 100.

In this embodiment, the fuel cell 201 is a polymer electrolyte fuel cell having a membrane electrode assembly 202, and two carbon separators 203 and 204 sandwiching the membrane electrode assembly 202 from both sides. Each of the two separators 203 and 204 has a gas flow path (not shown) through which reactant gas flows into the membrane electrode assembly 202 side. The fuel cell 201 generates electric power through a reaction of the reactant gas and outputs the electric power to the outside through the two separators 203 and 204.

The electronic load device 110 is configured to be capable of varying a load periodically at a variable frequency. The electronic load device 110 is electrically connected between the current collecting plate 111 and the terminal plate 107. The power density distribution measuring device 210 measures power density distribution based on the difference in electric potential between the two separators 203 and 204, and also based on the currents flowing through the measuring electrodes 120. The current flowing through each of the measuring electrodes 120 is measured in response to the output from a current sensor 126 attached to each of the measuring electrodes 120.

In this embodiment, the moisture content of different sections of (or moisture content distribution in) an electrolyte (not shown) of the membrane electrode assembly 202 sandwiched between the two separators 203 and 204 are estimated based on the power density distribution. The details of the measuring method are described later. The measurement is made based on the power density distribution so that the moisture content distribution in various power output states can be estimated. The moisture content distribution may also be estimated directly from the current density distribution.

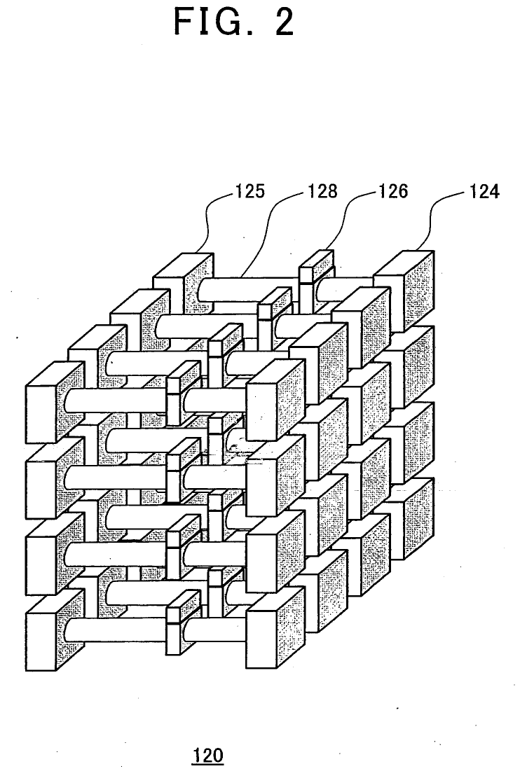

FIG. 2 is an enlarged view of a plurality of measuring electrodes 120 for measuring the current values output from different sections of the separator 204. Each of the measuring electrodes 120 has a rod 128, two current collection electrodes 124 and 125 connected to the opposite ends of the rod 128, and a current sensor 126.

In this embodiment, the current sensor 126 is a sensor using a Hall element capable of measuring changes in magnetic field at high sensitivity. The current sensor 126 outputs an electric signal in accordance with a magnetic field which changes depending on the current flowing through the corresponding rod 128.

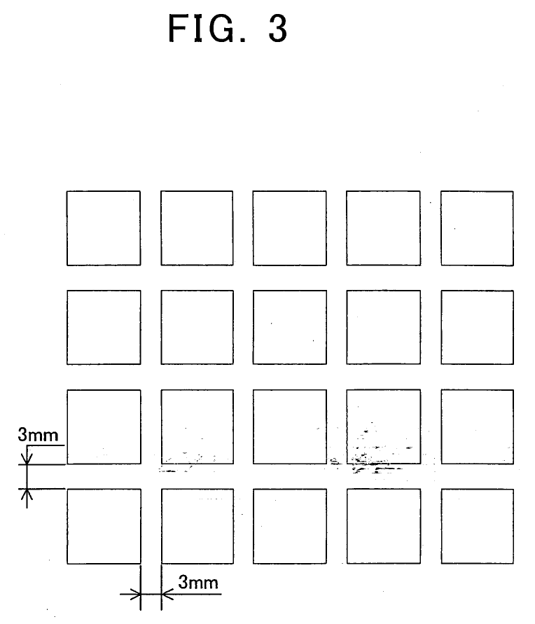

FIG. 3 is an explanatory view illustrating the arrangement of the current collection electrodes 125 on the separator 204 in the first embodiment of the present invention. In this embodiment, the distance between the current collection electrodes 125 is 3 mm. The distance between the current collection electrodes 125 is preferably equal to or smaller than the twice the widthwise pitch of the flow paths of the separator 204. This is because, in this configuration, the pressing force from the plurality of current collection electrodes 125 is transmitted uniformly to all the flow paths.

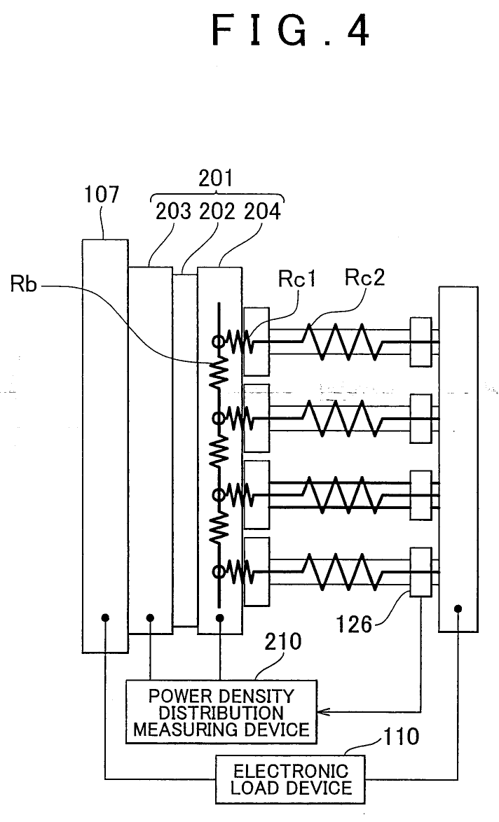

FIG. 4 is an explanatory view illustrating an equivalent circuit of an electric circuit including the internal state monitoring device 100 and the fuel cell 201. The equivalent circuit has the fuel cell 201, which generates electric power, resistances Rb, contact resistances Rc1, wiring resistances Rc2, and the electronic load device 110. The resistances Rb are resistances in the separator 204 between adjacent current collection electrodes 125. The contact resistances Rc1 are contact resistances due to contact between the current collection electrodes 125 and the separator 204. The wiring resistances Rc2 are wiring resistances in the entire internal state monitoring device 100.

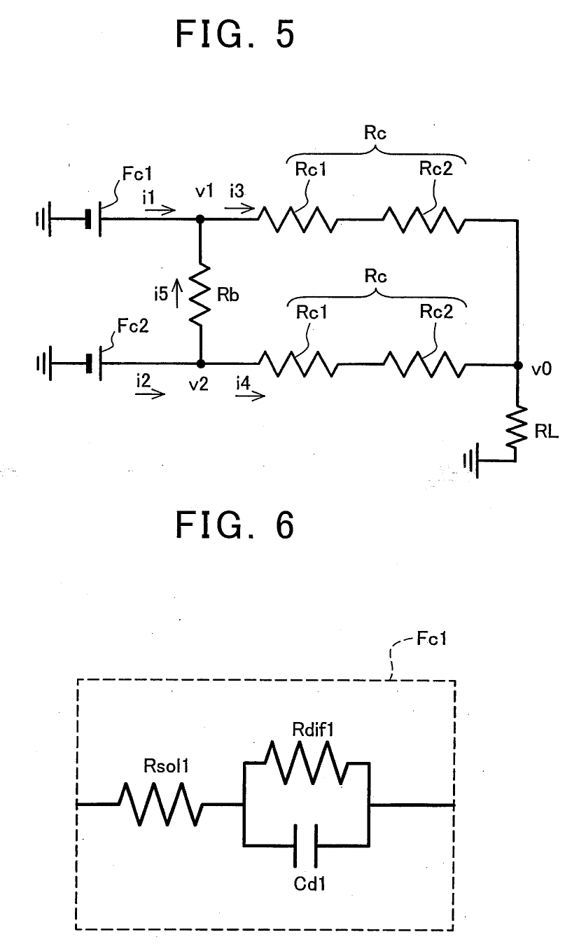

FIG. 5 is an explanatory view illustrating a part of the equivalent circuit for easy understanding. As described before, in this embodiment, the current values output from different sections of the separator 204 are measured to estimate the reaction state of reactant gas at sections Fc1 and Fc2 in the membrane electrode assembly 202. The measurement is made by measuring the current values flowing through the measuring electrodes 120. More specifically, current values i1 and i2 output in accordance with electric potentials v1 and v2, respectively, generated in different sections of the separator 204 are measured by measuring the current values i3 and i4 flowing through two measuring electrodes 120.

The current values i1 and i2 are, however, not simply proportional to the current values i3 and i4, respectively. This is because, since a current flows also in the separator 204, a current leaks from the section, where the electric potential v2 is generated, to the side of the measuring electrode 120 through which the current value i3 flows. A measuring method taking a quantitative analysis of such leakage into account is described later.

FIG. 6 is an explanatory view illustrating an example of an equivalent circuit of a section Fc1 of the fuel cell 201. For easy understanding, the equivalent circuit includes a single parallel circuit having a reaction resistance Rdif1 and an electric double-layer capacitance Cd1; and an electrolyte resistance Rsol1 connected in series with the parallel circuit. Here, the “reaction resistance Rdif1” corresponds to the losses caused by the supply of the reactant gas to the membrane electrode assembly 202 and the discharge of water therefrom. The “electric double-layer capacitance Cd1” corresponds to the losses caused by activation polarization of the membrane electrode assembly 202. The “electrolyte resistance Rsol1” is an inverse of the electric conductivity of the electrolyte (not shown) of the membrane electrode assembly 202. It is known that the electric conductivity highly depends on the moisture content of the electrolyte. In the embodiment described below, the moisture content of the electrolyte is estimated based on this dependency.

In this embodiment, the electrolyte resistance Rsol1 is measured to estimate the distribution of moisture content in different sections of the electrolyte. The measurement of the electrolyte resistance Rsol1 is made by separating the reaction resistance Rdif1 from a measurable resistance value (the internal resistance of the section Fc1 of the fuel cell 201). The separation of the reaction resistance Rdif1 is made by, for example, varying the load applied by the electronic load device 110 in a prescribed sufficiently short cycle (that is, at a prescribed high frequency) and extracting an alternating current component from the current value flowing through the corresponding measuring electrode 120 with a band-pass filter adapted to the prescribed cycle. The extraction process is performed by the power density distribution measuring device 210.

The reason why the separation is possible is that since the alternating current component of the output current from the fuel cell flows not through the reaction resistance Rdif1 but through the electric double-layer capacitance Cd1, which has a low impedance at high frequency, when the frequency is high, the measurable resistance value (the internal resistance of the section Fc1 of the fuel cell 201) becomes closer to the electrolyte resistance Rsol1. In particular, the membrane electrode assembly 202 is preferred since it forms an electric double-layer capacitance and has a significantly high electric capacitance of several farads. Since the alternating current component flows with less impedance through the electric double-layer capacitance Cd1 as the frequency of the varying load is higher, but the influence of inductance components of the circuit of the internal state monitoring device 100 and the fuel cell is inevitable when the frequency is too high. Therefore, the frequency of the varying load is preferably determined in view of the trade-off with such inductance components.

In addition, in this embodiment, since the power density distribution is measured using the difference in electric potential between the two separators 203 and 204, the power density distribution measuring device 210 can estimate the moisture content distribution in various output states of the fuel cell 201.

As described above, in the first embodiment, the moisture content distribution state in the electrolyte (not shown) of the membrane electrode assembly 202 can be monitored based on the distribution of alternating current power components (or alternating current components) contained in the output electric power from the fuel cell 201.

A second embodiment of the present invention is different from the first embodiment in that the influence of leakage currents in the separator 204 is removed from the alternating current density distribution based on the following analysis.

Circuit equations of the equivalent circuit shown in FIG. 5 are shown below. Here, for easy understanding of the circuit equations, the combined resistance of the contact resistances Rc1 and the wiring resistance Rc2 is defined as circuit resistance Rc. If v2>v1, the following equations are derived from Kirchhoff's law.

(1) i1+i2=i3+i4 Equation 1

(2) i3=i1+i5 Equation 2

(3) i4=i2−i5 Equation 3

Also, when attention is paid to the electric potential of each section, the following equations are derived.

(1) v1=v2−Rb×i5 Equation 4

(2) v0=v1−Rc×i3 Equation 5

(3) v0=v2−Rc×i4 Equation 6

When the simultaneous equations 1 to 6 are solved, the following equations are derived.

(1) i1=i3+Rc/Rb(i3−i4) Equation 7

(2) i2=i4+Rc/Rb(−i3+i4) Equation 8

Here, the currents i1 and i2 are the currents to be measured and the currents i3 and i4 are the currents which are measured by the current sensors 126. The second terms in the right-hand sides of equations 7 and 8 correspond to the currents which leak in the separator 204.

The measuring method of the second embodiment is a highly practical measuring method which is established by the present inventors in view of the fact that the second terms of equations 7 and 8 can be controlled by the hardware configuration of the internal state monitoring device 100. With this method, there can be obtained an advantage that measuring error caused by leakage currents which flow between a plurality of electrodes can be reduced to an expected allowable level with a simple configuration.

For example, when (current value i5)/(current value i2) (FIG. 5) is defined as allowable error Er and the expected maximum value of current output ratio at measuring points is defined as maximum output ratio Pr, it is understood that what is needed is to configure the hardware of the internal state monitoring device 100 such that the following Inequation 9 is satisfied by solving the simultaneous equations 1 to 6.

Er>ABS(1−((Pr+1)×Rc+Rb)/(2×Rc+Rb)) Inequation 9

where ABS (argument) means a function which returns the absolute value of the argument.

Such a hardware configuration can be realized by at least one of an “increase in the inter-contact-point resistance Rb” and a “decrease in the circuit resistance value Rc.” An “increase in the inter-contact-point resistance Rb” can be realized by, for example, an increase in the resistance value of a fuel cell or measuring jig having contact points or an increase in the pitch between contact points. A “decrease in the circuit resistance value Rc” can be realized by, for example, elimination of contact resistance by integration of the circuit of the measuring device or a decrease in the contact resistance by application of a liquid metal on the contact surfaces, which are described later.

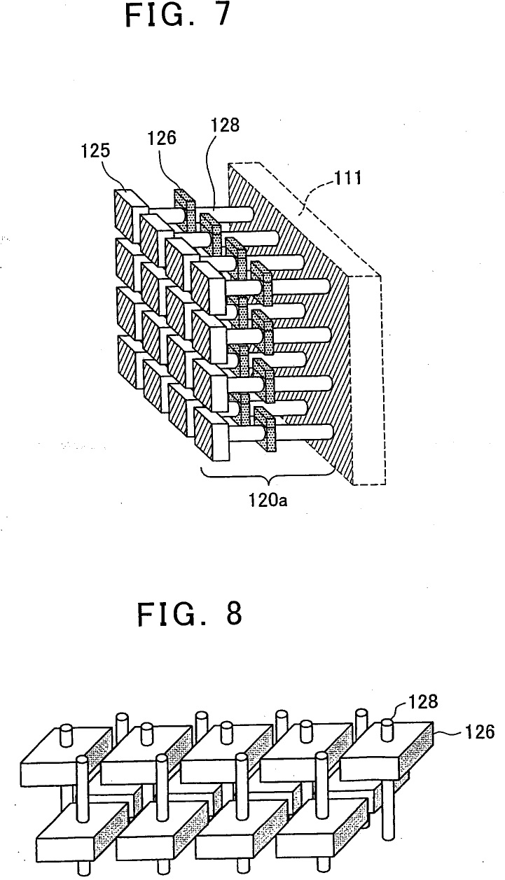

More specifically, a “decrease in the circuit resistance value Rc” can be achieved by applying a prescribed metal between the current collection electrodes 125 and the separator 204. Applicable metals include ductile metals such as indium and lead, and liquid metals such as gallium-indium alloy, mercury and sodium. From the viewpoint of reduction of the contact resistance, liquid metals are preferred. From the viewpoint of safety, an alloy containing gallium and indium such as gallium-indium alloy is preferred. A “decrease in the circuit resistance value Rc” can be also achieved when an integrated measuring electrode 120a (see FIG. 7) is formed by integrating the plurality of measuring electrodes 120 and the current collecting plate 111 to eliminate the contact resistance therebetween.

The measurement of the circuit resistance value Rc in configuring the hardware may be made regarding the combined resistance of the contact resistance between the current collection electrodes 125 and the separator 204 and the contact resistance between the measuring electrodes 120 and the current collecting plate 111 as the circuit resistance value Rc. This is because most of the circuit resistance value Rc is caused by the contact resistances. However, when the measuring electrodes 120 and the current collecting plate 111 are constituted as an integrated structure, the circuit resistance value Rc may be regarded as the contact resistance between the current collection electrodes 125 and the separator 204.

An “increase in the inter-contact-point resistance Rb” can be realized by making the separator 204 of a high-resistance material, by providing a plate with a large resistance value, such as a carbon plate, as a measuring tool between the separator 204 and the current collection electrodes 125, or by providing the configuration of the fourth modification, which is described later.

In addition, as a simpler configuration, the present inventors have found from a multiplicity of actual measurements that the current density distribution can be measured with practically satisfactory accuracy when the hardware is configured such that the circuit resistance value Rc is smaller than one-fifth of the inter-contact-point resistance Rb.

As described above, in the second embodiment, since the leakage currents can be decreased by the hardware configuration of the internal state monitoring device 100, there can be obtained an advantage that measuring error caused by leakage currents can be suppressed to facilitate the measurement of the current density distribution.

Although some embodiments of the present invention have been described, the present invention is not limited to the embodiments and can be implemented in various forms without departing from the scope thereof. For example, the following modifications are possible.

Although the current sensors 126 are located in the same position in the axial direction of the measuring electrodes 120 in the above embodiments, the current sensors 126 may be offset from each other in the axial-direction of the measuring electrode 120 as shown in, for example, FIG. 8 so that the pitch of the measuring electrodes 120 can be smaller than the size of the current sensors 126 in a direction perpendicular to the measuring electrodes 120. In this case, the density of measuring points can be increased with the size of the sensors sufficiently large to maintain the sensing accuracy.

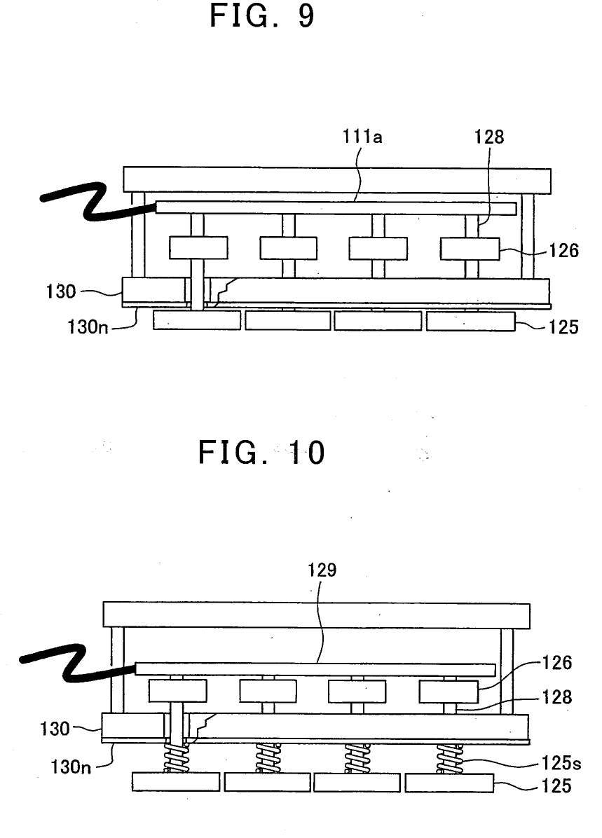

Although the current collecting plate 111 presses a plurality of measuring electrodes 120 against the fuel cell 201 (FIG. 1) in the above embodiments, a pressure plate 130 for pressing all the current collection electrodes 125 against the fuel cell 201 may be provided as shown in, for example, FIG. 9. In this case, variation of the pressing forces on the measuring electrodes 120 due to manufacturing tolerances in the length of the measuring electrodes 120 can be reduced.

The pressure plate 130 needs to have a higher rigidity in the surface pressure direction than that of a current collecting plate 111a. When the pressure plate 130 is made of a conductive material, an insulator 130n needs to be provided between the pressure plate 130 and the current collection electrodes 125 to prevent a short circuit between the current collection electrodes 125.

Also, urging springs 125s may be provided between the pressure plate 130 and the current collection electrodes 125 as shown in, for example, FIG. 10. In this case, the variation in the contact resistances between the cell electrodes and the reactant gas flow paths can be further reduced to improve the measurement accuracy.

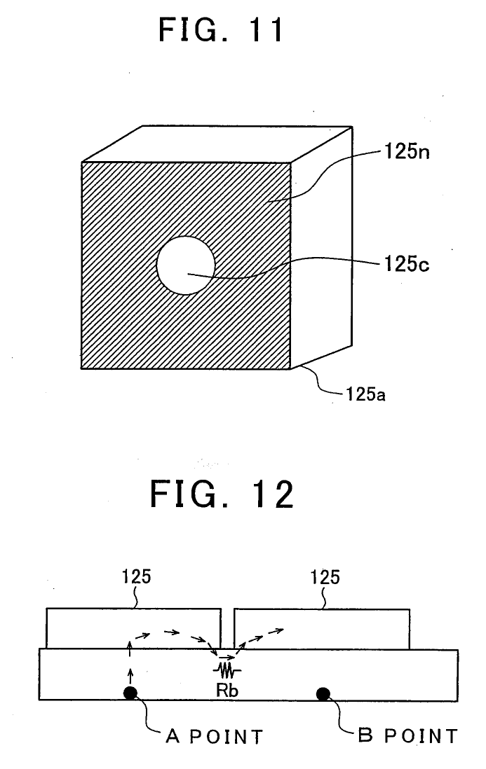

Although the entire contact surfaces of the current collection electrodes 125 are electrically conductive in the above embodiments, the contact surfaces may be formed as shown in, for example, FIG. 11. FIG. 11 is an explanatory view illustrating the contact surface of a current collection electrode 125. The contact surface has an insulating region 125n (with hatching) in which enamel coating is formed for insulation and a conductive region 125c which is electrically conductive. A liquid metal is coated in the conductive region 125c. The insulating region 125n is formed as a closed region surrounding the conductive region 125c.

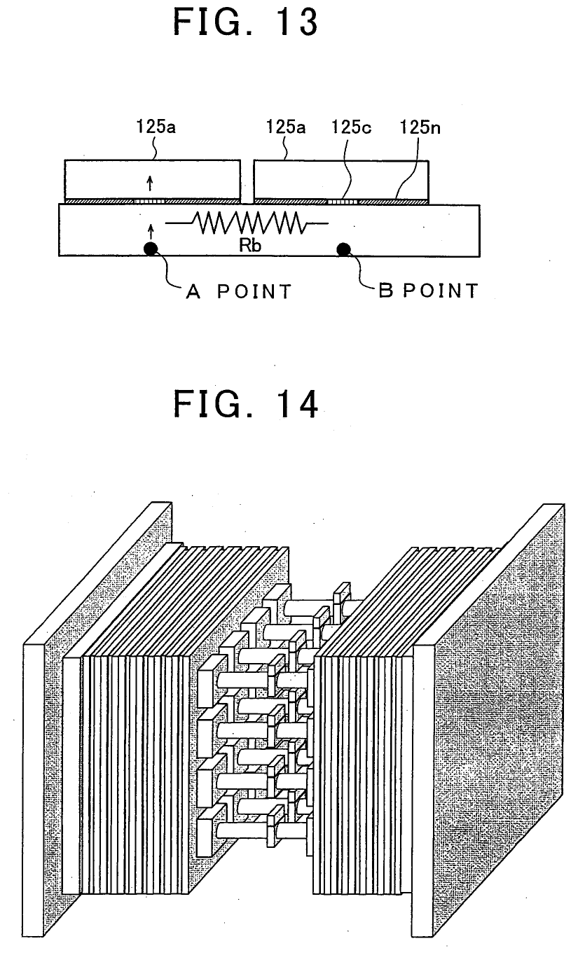

In this configuration, since a leakage current through the route as illustrated in FIG. 12 can be prevented, the distance between contact points can be decreased to make the pressing forces uniform and the inter-contact-point resistance Rb as shown in FIG. 13 can be increased.

Although the power density distribution output from the unit cells of the fuel cell 201 is measured from one side in the above embodiments, the measuring electrodes 120 may be interposed in the middle of the fuel cell stack as shown in, for example, FIG. 14. The present invention can be also implemented in various other forms including an internal state monitoring method and devices such as a fuel cell having the internal state monitoring device.

Although the moisture content of the electrolyte of a solid polymer electrolyte fuel cell is estimated in the above embodiments, the present invention is not limited to a polymer electrolyte fuel cell. When the present invention is applied to a fuel cell having a loss element which changes depending on different internal state parameters such as “activation polarization”, “diffusion polarization” and “resistance polarization,” the state quantity distribution of resistance polarization in the fuel cell can be separated from other losses (for example, “activation polarization” and “diffusion polarization”) and monitored.

The present invention is generally configured to extract alternating current components, contained in electrode currents, which are generated in response to changes in the load and monitor the distribution of a physical quantity (that is, state quantity) indicating the resistance polarization state of the fuel cell based on each extracted alternating current component. However, a solid polymer electrolyte fuel cell, in which an electric double-layer capacitance is formed between the electrolyte and the electrodes, has a significantly high electric capacitance. In addition, the estimation of the moisture content and a blocking state are very important since the approaches to deal with them are exactly the opposite. Therefore, the present invention has a pronounced effect.

In general, a fuel cell is constituted of a capacitance corresponding to “activation polarization,” a resistance corresponding to “diffusion polarization,” and a resistance corresponding to “resistance polarization,” and has a circuit in which a plurality of capacitance and resistance parallel circuits are connected in series and a resistance connected in series with the circuit. Also in this case, the “resistance polarization” can be separated from the “diffusion polarization” using a varying load in the same manner as described above. Here, the “activation polarization” is a loss caused by the need of energy for activation by the electrode, and so on, of the fuel cell. The “resistance polarization” is a loss caused by electrolyte resistance or the resistance between the electrolyte resistance and electrodes. The “diffusion polarization” is a loss caused by the supply of reactants to the electrolyte and the removal of reaction products from the electrolyte.

To “monitor” in the present invention has a wide meaning and includes acquiring a measurement value having a strong correlation with a state quantity of resistance polarization in the fuel cell (for example, current density distribution).

1. An internal state monitoring device for monitoring an internal state of a fuel cell having an electrolyte and a plurality of separators sandwiching the electrolyte, comprising:
a plurality of electrodes for electrical conduction with a plurality of regions on a surface of a first one of the plurality of separators through contact therewith at prescribed contact points in the fuel cell;
a collecting portion for collecting currents flowing through the plurality of electrodes to give the same electric potential to the electrodes;
sensors for measuring electrode currents flowing through the plurality of electrodes;
a load device connected to the fuel cell via the collecting portion and a second one of the plurality of separators for variably controlling a load applied between the collecting portion and the second one of the plurality of separators; and
an extracting-monitoring device for extracting alternating current components, contained in each of the measured electrode currents, generated in response to a change in the load and monitoring the distribution of a state quantity of resistance polarization in the fuel cell based on each of the extracted alternating current components.

2. The internal state monitoring device according to claim 1, wherein the fuel cell has a membrane electrode assembly, and wherein the extracting-monitoring device estimates the moisture content distribution state of the membrane electrode assembly based on the monitored distribution state of a state quantity of resistance polarization.

3. The internal state monitoring device according to claim 1, wherein the extracting-monitoring device measures the output voltage of the fuel cell not via the collecting portion but directly, and monitors the distribution of a state quantity of resistance polarization in the fuel cell in each output state based on the output voltage.

4. The internal state monitoring device according to claim 1, wherein the extracting-monitoring device measures each of the alternating current components depending on an inter-contact-point resistance Rb as a resistance value between the prescribed contact points in the fuel cell, a circuit resistance value Rc as a combined resistance value between the prescribed contact points and the collecting portion, and each of the measured electrode currents, and when an expected maximum value of the current output ratio of the fuel cell between the prescribed contact points is defined as maximum output ratio Pr and the allowable error is defined as Er, each of the alternating current components satisfies the following relation, and the currents measured at the plurality of electrodes are regarded as currents output at the contact points where the electrodes are in contact with the first one of the plurality of separators:
Er>ABS(1−((Pr+1)×Rc+Rb)/(2×Rc+Rb)),
where the ABS (argument) is a function which returns the absolute value of the argument.

5. The internal state monitoring device according to claim 4, wherein the circuit resistance value Rc is equal to or smaller than one-fifth of the inter-contact-point resistance Rb, and the currents measured at the plurality of electrodes are regarded as currents output at the contact points where the electrodes are in contact with the first one of the plurality of separators.

6. The internal state monitoring device according to claim 4, wherein the current density distribution is measured regarding the circuit resistance value Rc as a combined resistance of a contact resistance between the prescribed contact points in the fuel cell and the electrodes and a contact resistance between the electrodes and the collecting portion.

7. The internal state monitoring device according to claim 4, wherein the plurality of electrodes and the collecting portion are formed integrally, and wherein the current density distribution is measured regarding the circuit resistance value Rc as a contact resistance between the prescribed contact points in the fuel cell and the electrodes.

8. The internal state monitoring device according to claim 1, wherein a liquid metal is applied between the plurality of electrodes and the fuel cell to decrease the contact resistance between each of the plurality of electrodes and the fuel cell.

9. The internal state monitoring device according to claim 8, wherein the liquid metal is an alloy containing gallium and indium.

10. The internal state monitoring device according to claim 1, wherein the fuel cell has cell electrodes having reactant gas flow paths, and wherein the distance between contact surfaces between the plurality of electrodes and the fuel cell is equal to or smaller than the twice the widthwise pitch of the reactant gas flow paths.

11. The internal state monitoring device according to claim 1, wherein the sensors are offset from each other in the axial direction of the plurality of electrodes so that the pitch between the plurality of electrodes can be smaller than the size of the sensors in a direction perpendicular to the axial direction of the plurality of electrodes.

12. The internal state monitoring device according to claim 1, wherein the fuel cell has cell electrodes having reactant gas flow paths, each of the plurality of electrodes having an electrode rod for directing a current to the collecting portion and a contact terminal with an area greater than the cross-sectional area of the electrode for contacting at the prescribed contact point in the fuel cell, and the extracting-monitoring device further includes a pressure plate for pressing all the contact terminals against the fuel cell.

13. The internal state monitoring device according to claim 12, further comprising:
urging portions provided between each of the contact terminals and the pressure plate.

14. The internal state monitoring device according to claim 1, wherein each of the plurality of electrodes further includes a contact surface having a center region for electrical conduction through contact and a closed peripheral region surrounding the center region, and the peripheral region is insulated.

15. The internal state monitoring device according to claim 1, wherein the fuel cell has a plurality of sets of the electrolyte and the separators stacked therein, and the plurality of electrodes are interposed between the plurality of sets of the electrolyte and the separators.

16. An internal state monitoring method for monitoring an internal state of a fuel cell having an electrolyte and a plurality of separators sandwiching the electrolyte, comprising:
preparing a plurality of electrodes for electrical conduction with a plurality of regions on a surface of a first one of the plurality of separators through contact therewith at prescribed contact points in the fuel cell and a collecting portion for collecting the currents flowing through the plurality of electrodes to give the same electric potential to the electrodes;
measuring the electrode currents flowing through the plurality of electrodes;
variably controlling a load applied between the collecting portion and a second one of the plurality of the separators using a load device connected to the fuel cell via the collecting portion and a second one of the plurality of separators; and
extracting alternating current components, contained in each of the measured electrode currents, generated in response to a change in the load and monitoring the distribution of a state quantity of resistance polarization in the fuel cell based on each of the extracted alternating current components.
